(19) United States
(12) Patent Application Publication
(10) Pub. No.: US 2017/0203340 A1
(43) Pub. Date: Jul. 20, 2017

(54) RAPID CLEANING METHOD FOR ULTRAPURE WATER PIPING SYSTEM

(71) Applicants: GENERAL ELECTRIC COMPANY, Schenectady, NY (US); NATIONAL UNIVERSITY OF SINGAPORE, Singapore (SG)

(72) Inventors: Paul TAN, Singapore (SG); Derrick Kok Sing TAY, Singapore (SG); Rui GUO, Singapore (SG); Xuan Hao LIN, Singapore (SG); Fong Yau LI, Singapore (SG)

(21) Appl. No.: 15/326,690

(22) PCT Filed: Jul. 28, 2014
(86) PCT No.: PCT/US2014/048468

§ 371 Date: Jan. 17, 2017

(51) Int. Cl. B08B 9/08; B08B 3/08; B08B 9/032

(52) U.S. Cl. CPC B08B 9/0856; B08B 9/0321; B08B 3/08

(57) ABSTRACT

A cleaning method including an alkaline cleaning step followed by an acid cleaning step is used, for example, to treat a newly constructed ultrapure water distribution piping system (using PVDF piping system). The inherent inorganic and organic contaminants in the piping material as well as contaminants deposited (if any) during the construction phase can be removed efficiently. Therefore, the commissioning time of a newly constructed ultrapure water distribution system to meet the specified quality of contaminants can be shortened from several weeks to approximately one week.

### TECHNICAL FIELD

Embodiments of the invention relate to methods of cleaning an ultrapure water distribution piping system (using PVDF piping system), and removing the inorganic and organic impurities efficiently to meet the specified quality within a short period in fields such as the microelectronics industry.

### BACKGROUND

Ultrapure water is the prime cleansing agent in semiconductor manufacturing; hence, the quality of ultrapure water is stringently specified.

In an ultrapure water supply system, the purified water is carried from the ultrapure water plant to the point of use by the water distribution piping system.

As a highly non-reactive and pure thermoplastic polymer, polyvinylidene fluoride (PVDF) has been used as one of the common piping materials for ultrapure water distribution systems in the semiconductor industry. Conventionally, the commissioning of a newly constructed ultrapure water distribution system (PVDF piping system) to meet the specified quality of contaminants will take a few weeks to remove the impurities, such as metal ions, fluoride ion, and organic compounds, inherent in the piping material as well as contaminants deposited (if any) during the construction phase. And in this conventional method, ultrapure water is used as the cleaning solution for the newly constructed PVDF piping systems to eliminate the leachates from the piping materials.

Some methods of cleaning and sterilizing the ultrapure water system include the use of an alkaline solution (particularly ammonium hydroxide solution) and then use of hydrogen peroxide solution to complete the cleaning process. However, to efficiently remove the impurities, higher concentrations of alkaline solution and hydrogen peroxide solution (e.g., 0.01 to 10% by weight) and a higher temperature (e.g., more than 40° C.) are required. For ultrapure water distribution systems made from PVDF materials, such methods have the potential to cause degradation of the piping.

### BRIEF DESCRIPTION

Embodiments of the present invention provide a method to effectively and efficiently remove the inorganic impurities (particularly metal ions and fluoride ions) and organic impurities inherent or deposited in PVDF piping materials of a newly constructed or existing ultrapure water distribution piping system. The cleaning method includes an alkaline treatment step, followed by a first rinsing step. After the first rinse, the ultrapure water system is then treated with acid, and then a second rinsing step to rinse out the chemical and impurities. The alkaline treatment agent used in this method includes ammonium hydroxide and the alkali metal hydroxides such as sodium hydroxide, potassium hydroxide. The acid used in this method may include a mineral acid such as nitric acid, sulphuric acid, and hydrochloric acid. The concentration of the chemicals (alkaline treatment agent and acid) used for the chemical treatment step can be as low as a few ppm level. In one embodiment of the invention, the whole cleaning process is performed at ambient temperature.

According to one aspect of the inventive method, the inorganic and organic impurities in a newly constructed or existing piping system can be efficiently and effectively removed. This will significantly reduce the commissioning time of a newly constructed ultrapure water distribution system from a few weeks to approximately one week.

In one embodiment, the invention is directed to a method for cleaning an ultrapure water supply system or component part thereof comprising the steps of contacting the system or component part with an alkaline cleaning solution; and rinsing the ultrapure water supply system or component part thereof. Then, the method comprises contacting the system or component part with an acidic solution; and rinsing the system or component part thereof that has been contacted with an acidic solution.

In accordance with other embodiments of the invention, the ultrapure water system comprises component parts thereof composed of polyvinylidene difluoride (PVDF).

In another aspect of the invention, the alkaline cleaning solution comprises NH₄OH or alkali metal hydroxide such as NaOH or KOH.

In other aspects of the invention, the acidic solution adapted for use in the method comprises a mineral acid, and in other embodiments, the mineral acid comprises nitric acid, sulfuric acid, or hydrochloric acid. In certain aspects of the invention, all of the method steps are conducted at ambient temperature.

In other exemplary embodiments, the amount of alkaline material present in the alkaline solution is about 0.5-200 ppm based on the volume of the alkaline solution used in the cleaning process. In some embodiments, the alkaline material present is within the range of about 2 to about 10 ppm based on one million parts of the alkaline solution.

The amount of mineral acid present in the acidic solution may be, in one embodiment, present in an amount of about 0.5 ppm to about 200 ppm, or more particularly from about 2 to about 10 ppm based on one million parts per volume of the acidic solution.

In additional embodiments, the alkaline cleansing step may be performed for a period ranging from about 12 hours to about 15 days, or more particularly, from about 2 to about 5 days.

The cleaning method may be performed in either a dynamic or static state. In a dynamic state, the treatment components are caused to flow through the system or system components. For example, with regard to the rinsing steps, these may be, in one embodiment, carried out in a dynamic state in which the rinsing solutions are caused to flow through the ultrapure water system or component part thereof at a flow rate of about 0.2 m/s or greater.

In other embodiments, the cleaning method may be conducted at temperatures of about 10-40° C., or more particularly, from about 20-30° C.

In one exemplary embodiment, the ultrapure water system is a newly constructed or newly installed ultrapure water supply system.

### BRIEF DESCRIPTION OF THE DRAWINGS

The objects, advantages and other features of the present invention will become more apparent upon reading of the following non-restrictive description of embodiments thereof, given for the purpose of exemplification only, with reference to the accompany drawings, through which similar reference numerals may be used to refer to similar elements.

FIG. 1 is a graph showing the leaching rate of inorganic impurities (metal ions) from piping materials treated with ultrapure water (Control Treatment 1), nitric acid solution (Chemical Treatment 1), hydrogen peroxide solution (Chemical Treatment 2), ammonium hydroxide solution (Chemical Treatment 3), and sodium hydroxide solution (Chemical Treatment 4), respectively, as the treatment days prolonged.

FIG. 2 is a graph showing the leaching rate of inorganic impurities (metal ions) from piping materials treated with nitric acid solution with concentration of 2 ppm (Chemical Treatment 1), 10 ppm (Chemical Treatment 5), and 200 ppm (Chemical Treatment 6), respectively, as the treatment days prolonged.

FIG. 3 is a graph showing the leaching rate of fluoride ion from piping materials treated with ultrapure water (Control Treatment 1), nitric acid solution (Chemical Treatment 1), hydrogen peroxide solution (Chemical Treatment 2), ammonium hydroxide solution (Chemical Treatment 3), and sodium hydroxide solution (Chemical Treatment 4), respectively, as the treatment days prolonged.

FIG. 4 is a graph showing the leaching rate of organic impurities from piping materials treated with ultrapure water (Control Treatment 1) and chemical treatment with nitric acid solution (Chemical Treatment 5) or sodium hydroxide solution (Chemical Treatment 4) as the treatment days prolonged.

FIGS. 5A, 5B, and 5C are the graphs showing the comparison of the leaching rate of inorganic impurities, i.e., metal ions (FIG. 5A) and fluoride ion (FIG. 5B), and organic impurities (FIG. 5C) from piping materials treated with ultrapure water (Control Treatment 2) and chemical solution of sodium hydroxide followed by nitric acid (Chemical Treatment 7), respectively.

FIGS. 6A, 6B, and 6C are the graphs showing the comparison of the leaching rate of inorganic impurities, i.e., metal ions (FIG. 6A) and fluoride ion (FIG. 6B) and organic impurities (FIG. 6C) from piping materials by using chemical solution of sodium hydroxide followed by nitric acid with flow rate of 0.0 m/s (Chemical Treatment 8), 0.2 m/s (Chemical Treatment 9), and 0.6 m/s (Chemical Treatment 10), respectively.

FIG. 7 is bar chart showing the impurities amount of metal ion (calcium), fluoride ion, and organic compounds leach out from the piping materials with and without applying chemical treatment after seven days.

### DETAILED DESCRIPTION

After an ultrapure water distribution piping systems (PVDF piping system) is newly constructed, the commissioning of the piping system to meet the specified quality is required in order to allow leach out of the inherent inorganic and organic contaminants in the piping material as well as contaminants deposited (if any) during the construction phase. Conventionally, ultrapure water is used to flush the PVDF piping system during commissioning period to thoroughly remove the inorganic and organic impurities. However, it will take a few weeks to meet the specified quality by using this method. In embodiments of the present invention, a chemical cleaning process including an alkaline treatment step, first rinsing step, an acid treatment step, and second rinsing step, is provided. The alkaline material used in this method includes ammonium hydroxide and the alkali hydroxides such as sodium hydroxide, potassium hydroxide. The acid used in this method includes mineral acids such as nitric acid, sulphuric acid, and hydrochloric acid. Since the alkaline solution is effective in leaching organic and inorganic (especially fluoride ion) impurities and the acid solution is effective in leaching organic and inorganic (especially metal ions) impurities efficiently within the span of around one week, the inorganic and organic contaminants in the piping materials can be effectively and efficiently removed by using this chemical cleaning method. Hence, in accordance with this aspect of the invention, the commissioning time of a newly constructed distribution piping system (PVDF piping system) can be significantly shortened to approximately a week.

To illustrate the effectiveness and efficiency of alkaline solution and acid solution in leaching inorganic and organic impurities from PVDF piping materials, the following tests have been performed on PVDF test spools composed of fresh PVDF piping, elbows, and end caps at room temperature (22° C.) on a class 10 clean bench.

After pre-cleaning with ultrapure water, a fresh PVDF test spool is soaked with ultrapure water (for control treatment) or ultrapure grade chemical diluted with ultrapure water to the required concentrations (for chemical treatment) at room temperature (22° C.) for a specified number of days in a static state. Water samples are collected at different treatment days. The inorganic and organic impurities in each sample are analyzed by inductively coupled plasma mass spectrometry (ICP-MS), ion chromatography (IC), and TOC analyzer, respectively.

Four kind of chemicals (ultrapure grade), i.e., acid (nitric acid), alkaline treatment (sodium hydroxide or ammonium hydroxide), and hydrogen peroxide, have been used to perform the chemical treatment, respectively. Four parallel chemical treatment tests (as below) have been completed.

Chemical Treatment 1: treated with nitric acid solution (with concentration around 2 Ppm).

Chemical Treatment 2: treated with hydrogen peroxide solution (with concentration around 200 ppm).

Chemical Treatment 3: treated with ammonium hydroxide solution (with concentration around 200 ppm).

Chemical Treatment 4: treated with sodium hydroxide solution (with concentration around 10 ppm).

Table 1 shows the leaching amount of some critical metal ions (i.e., calcium, aluminum, copper, and zinc) in piping materials treated with ultrapure water (Control Treatment 1) and different chemicals (chemical treatment) after seven days at test temperature (22° C.).

TABLE 1

| | | | Chemi- | Chemi- | Chemi- | Chemi- |
|---|---|---|---|---|---|---|
| | | Control | cal | cal | cal | cal |
| | | Treat- | Treat- | Treat- | Treat- | Treat- |
| | | ment 1 | ment 1 | ment 2 | ment 3 | ment 4 |
| Total amount | Ca | 0.10 | 1.35 | <0.1 | <0.1 | <0.1 |
| of Metal ions | Al | 0.05 | 1.95 | 1.90 | 1.10 | 1.75 |
| leached out | Cu | 0.05 | 0.60 | <0.1 | <0.1 | 0.30 |
| (μg/m²) | Zn | 0.95 | 3.00 | 0.80 | <0.1 | 0.15 |

It can be seen that after seven days treatment, the amount of critical metal ions leached out from the piping material by Chemical Treatment 1 is obviously higher than the amount of the metal ions leached out by the control treatment. And the leached amount of metal ions by using Chemical Treatment 1 is also higher as compared with other Chemical Treatment 2 to Chemical Treatment 4. This illustrates that Chemical Treatment 1 with nitric acid is more effective than ultrapure water treatment and the other chemicals (i.e., alkaline material and hydrogen peroxide) in leaching of metal ions from PVDF piping material. The enhanced solubility of the metal ions can be one of the reasons for this effect.

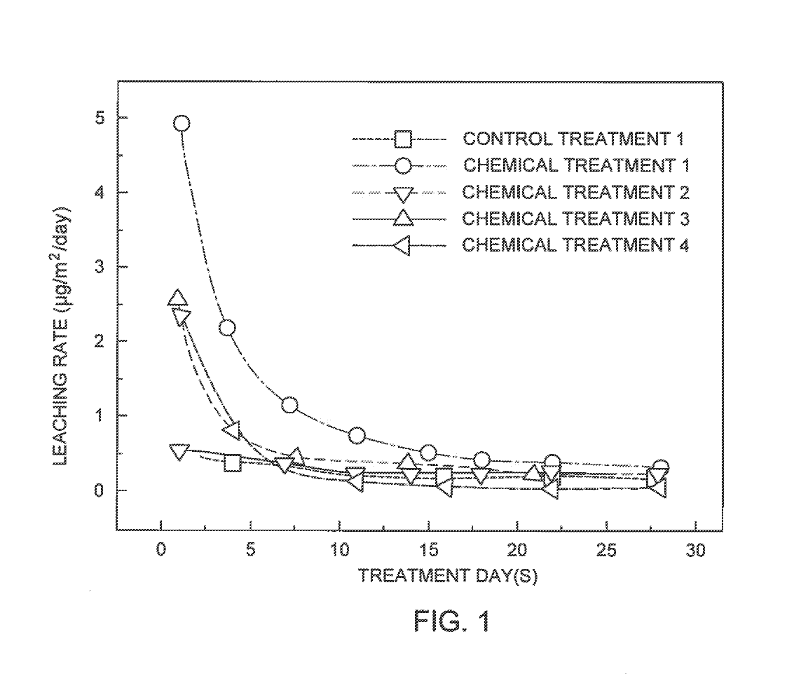

Based on the total leached amount (μg/m²) of all the critical metal ions, the leaching rate (μg/m²/day) can be calculated. FIG. 1 shows the leaching rate of inorganic impurities (metal ions) from piping materials treated with ultrapure water (control treatment) and different chemicals (chemical treatments) as the treatment days prolonged. The results show that the leaching rate of the metal ions with Chemical Treatment 1 is higher as compared with control treatment and other chemical treatment tests, especially at the initial treatment days (two to seven days). And actually, the leaching amount of the metal ions impurities by using Chemical Treatment 1 at the initial three treatment days is more than 80% of the total leaching amount of metal ions of the whole treatment process (30 treatment days). It indicates that most of the impurities are leached out at this initial treatment period. Such results indicate that Chemical Treatment 1 with nitric acid is not only effective but also efficient in leaching of inorganic (metal ions) impurities from PVDF piping materials.

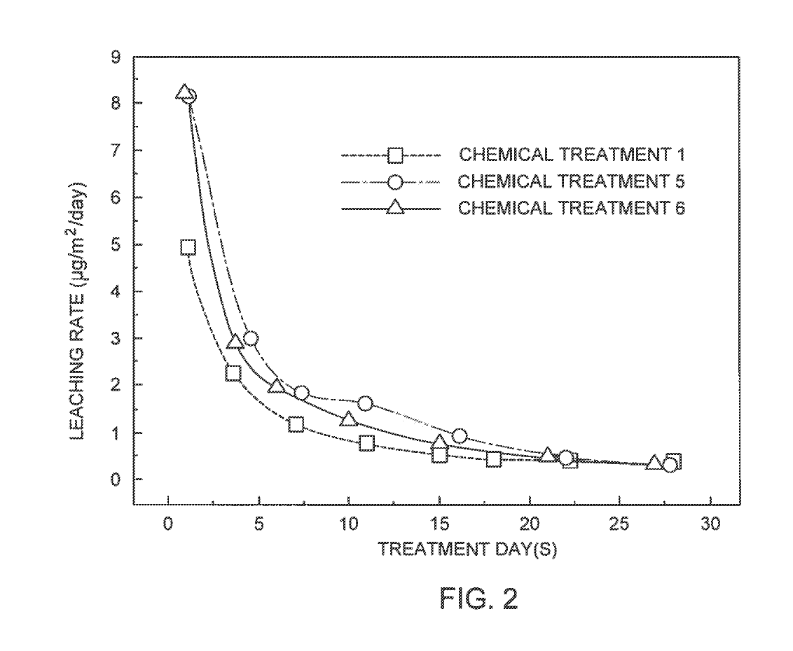

The influence of the concentration of acid solution on the effectiveness of chemical treatment in leaching of inorganic (metal ions) is also investigated. Besides Chemical Treatment 1 using nitric acid solution with concentration around 2 ppm, Chemical Treatment 5 using nitric acid solution with concentration around 10 ppm and chemical treatment 6 using nitric acid solution with concentration around 200 ppm have been performed, respectively. FIG. 2 shows the comparison of the leaching rate of inorganic impurities (metal ions) from piping materials using Chemical Treatment 1, Chemical Treatment 5, and Chemical Treatment 6 as the treatment days prolonged.

The results in FIG. 2 indicate that compared with Chemical Treatment 1 using nitric acid solution with concentration around 2 ppm, the leaching rate of Chemical Treatment 5 using nitric acid solution with concentration around 10 ppm is higher, especially at the initial treatment days. However, further increasing the concentration of nitric acid solution to 200 ppm, there is no significant difference in the leaching rate for Chemical Treatment 6 as compared with Chemical Treatment 5. In embodiments of the present invention, the effectiveness of the acid treatment will keep constant while the concentration of acid solution set from 0.5 ppm to 200 ppm, and 10 ppm is the optimum concentration of nitric acid to use at the test temperature (22° C.).

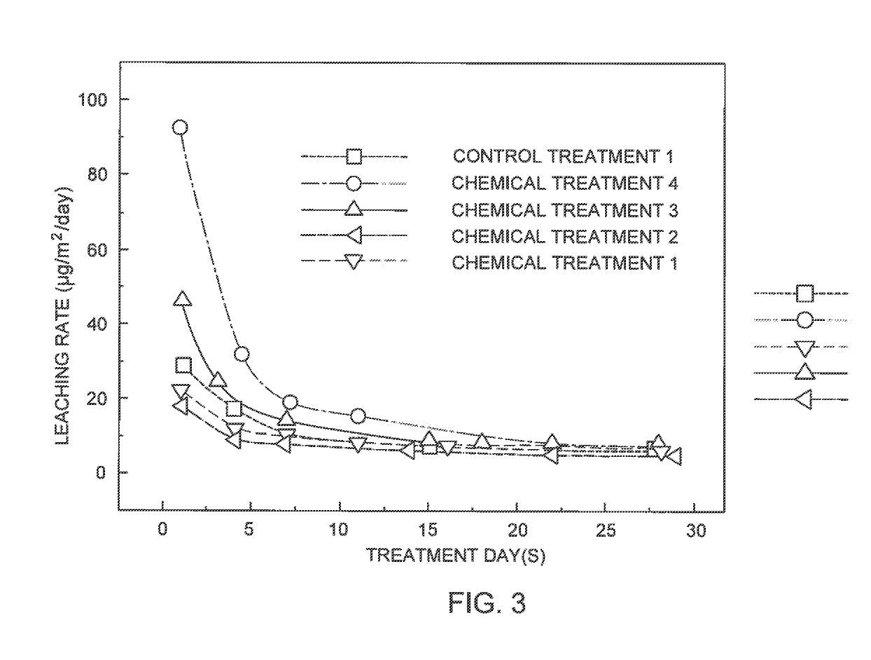

Besides the critical metal ions, fluoride ion has been considered as one of the major inorganic impurities for ultrapure water distribution piping systems constructed with PVDF materials. FIG. 3 shows the leaching rate of fluoride ion from piping materials treated with ultrapure water (control treatment) and different chemicals (chemical treatment) as the treatment days prolonged.

The results show that compared with control treatment and other chemical treatment, the leaching rate of Chemical Treatment 4 (sodium hydroxide solution) is significantly higher, especially at the initial treatment days (two to seven days). And the leaching amount of the fluoride ions impurities by using Chemical Treatment 4 at the initial three treatment days is more than 70% of the total leaching amount of fluoride ions of the whole treatment process (30 treatment days). It indicates that most of the fluoride impurities are leached out at this initial treatment period. Furthermore, apart from Chemical Treatment 3 (ammonium hydroxide solution), the leaching rate of the other chemical, mainly nitric acid solution and hydrogen peroxide solution, is similar or lower than the leaching rate of the control treatment.

Although applicants are not to be bound by any theory of operation, the reason for these results can be explained as below. During the chain stripping process of PVDF materials, a hydrofluoric acid molecule will be eliminated. And the hydrofluoric acid molecule exists as a hydrated proton and a fluoride anion in solution. Under the condition of chemical treatments with nitric acid solution or hydrogen peroxide solution (which will provide hydrated proton), the extra hydrated proton may suppress the elimination of the hydrofluoric acid. However, under the condition of chemical treatment with ammonium hydroxide or sodium hydroxide, a proton will be consumed, which may accelerate the leaching of the fluoride ion. In such case, a basic condition is favorable in leaching of fluoride impurities from PVDF piping materials. And compared with ammonium hydroxide, an alkali metal hydroxide, such as sodium hydroxide, is more effective and efficient in leaching of fluoride ion from PVDF piping materials. The lower concentration of alkali metal hydroxide solution may eliminate the influence of the basic solution on the degradation of PVDF materials.

The results shown in FIG. 1 and FIG. 3 indicate that chemical treatment with acid solution can effectively and efficiently accelerate the leaching of inorganic impurities (metal ions) from PVDF piping materials, while chemical treatment with alkali metal hydroxide solution is effective and efficient for removing fluoride ion.

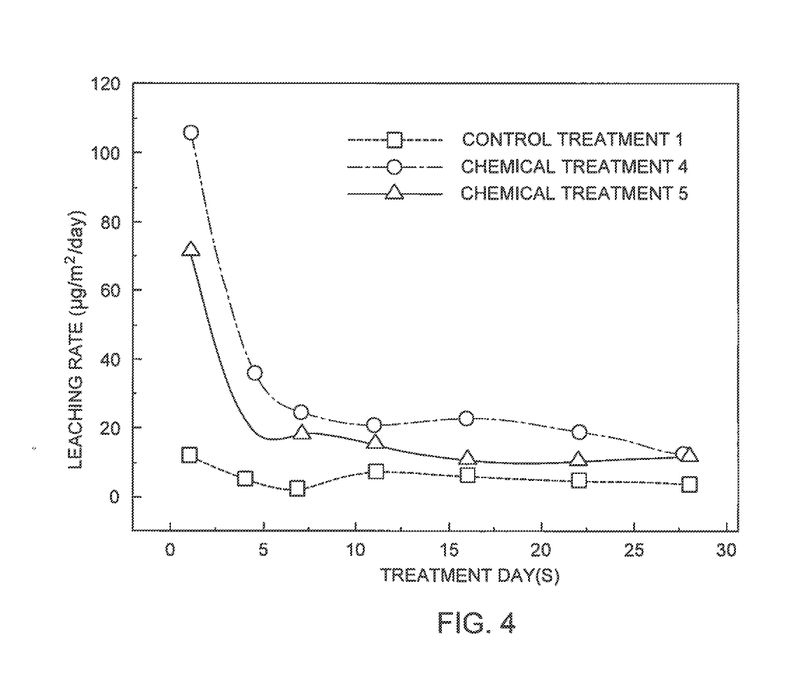

The effectiveness of these two chemicals in leaching of organic impurities from PVDF piping materials is also investigated. FIG. 4 shows the results of the leaching rate of organic impurities from piping materials by chemical treatment 4 using sodium hydroxide solution with concentration around 10 ppm and by Chemical Treatment 5 using nitric acid solution with concentration 10 ppm. The results show that compared with Control Treatment 1, the leaching rate of the chemical treatment with nitric acid solution or sodium hydroxide solution is higher, especially at the initial treatment days (two to seven days). The leaching amount of the organic impurities by using Chemical Treatment 4 or Chemical Treatment 5 at the initial three treatment days is more than 70% to 75% of the total leaching amount of organic impurities of the whole treatment process (30 treatment days). It indicates that most of the impurities have been leached out at this initial treatment period. The results indicate that both these two chemical treatments are effective and efficient in leaching of organic impurities from PVDF piping materials.

Based on the above results, in one embodiment, a combined chemical treatment process is invented to clean a newly constructed distribution PVDF piping system. It includes an alkaline treatment cleaning step, a first rinsing step, an acid treatment step, and a second rinsing step. The alkaline treatment includes ammonium hydroxide and an alkali metal hydroxide such as sodium hydroxide or potassium hydroxide, while the acid includes a mineral acid such as nitric acid, sulphuric acid, and hydrochloric acid. The concentration of the alkali metal hydroxide solution and the acid solution can be set from 0.5 ppm to 200 ppm, respectively. And the duration for each step of chemical treatment can be set from 12 hours to 15 days.

To illustrate the effectiveness of this cleaning method, the following tests, i.e., Control Treatment 2 (using ultrapure water) and Chemical Treatment 7 (using sodium hydroxide and nitric acid), have been performed as below. The concentration of each chemical solution (sodium hydroxide and nitric acid) is set as 10 ppm, and the duration of each cleaning step for these tests is set as three days.

Control Treatment 2: treated with ultrapure water for three days, first rinsing, then treated with ultrapure water for another three days, second rinsing.

Chemical Treatment 7: treated with sodium hydroxide solution (with concentration at 10 ppm) for three days, first rinsing, then treated with nitric acid solution (with concentration at 10 ppm) for another three days, second rinsing.

In detail, after pre-cleaning by ultrapure water, the fresh PVDF test spool is first soaked with ultrapure water (for control treatment) or 10 ppm sodium hydroxide solution (for Chemical Treatment 7) at room temperature (22° C.) for three days in static state. After treatment for three days, the solution inside the PVDF test spool is dumped and the PVDF test spool is then rinsed with ultrapure water for several minutes with a flow rate less than 0.1 m/s. The completion of the rinsing step can be determined by the pH of the rinsing water, which reaches a predetermined pH level of 7.0 to 7.5. After the first rinsing step is completed, the rinsing water is dumped and the PVDF test spool is then soaked with ultrapure water (for control treatment) or 10 ppm nitric acid solution (for Chemical Treatment 7) at room temperature (22° C.) for three days in static state. After the acid treatment, the second rinsing step is performed. Similar with the first rinsing step, the piping material is rinsed with ultrapure water for several minutes with a flow rate less than 0.1 m/s. The completion of the second rinsing step can be determined by the pH of the rinsing water, which reaches a predetermined pH level of 7.0 to 7.5.

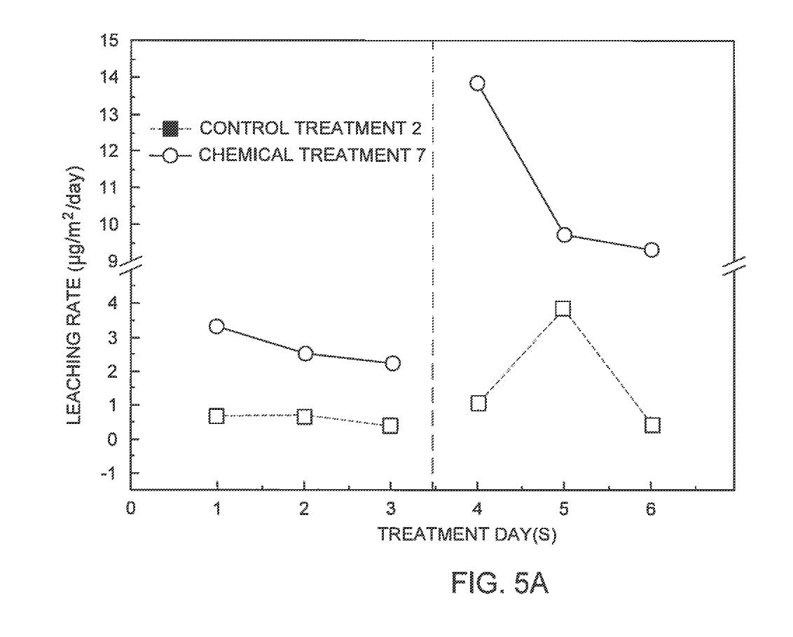

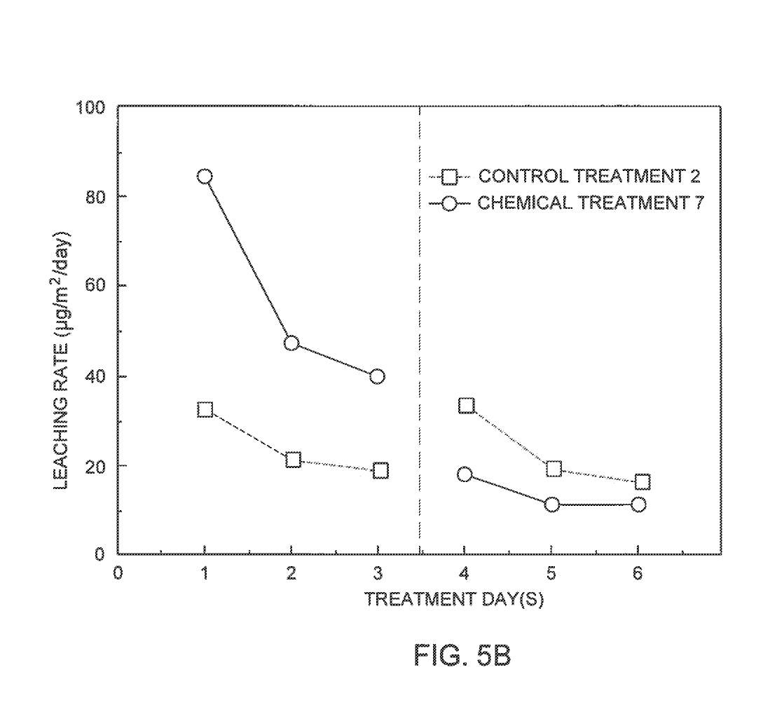

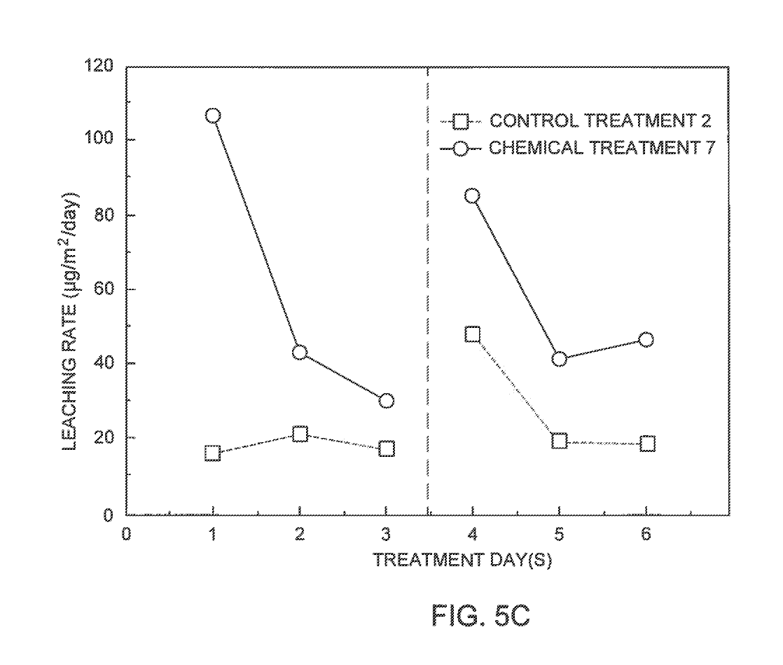

FIG. 5A to FIG. 5C show the leaching rate of inorganic impurities, i.e., metal ions and fluoride ion, and organic impurities, from piping materials for Control Treatment 2 and Chemical Treatment 7, respectively.

For the metal ions impurities, the results shown in FIG. 5A indicate that at the first three treatment days with sodium hydroxide, the leaching rate of Chemical Treatment 7 is slight higher than the rate of Control Treatment 2. While for the second three treatment days with nitric acid, the leaching rate of Chemical Treatment 7 is significantly higher than the Control Treatment 2. Such results further illustrate the nitric acid solution is more effectiveness in leaching of metal ions impurities as compared with ultrapure water and sodium hydroxide.

Similarly, for the fluoride impurities, the results shown in FIG. 5B indicate that at the first three treatment days with sodium hydroxide, the leaching rate of Chemical Treatment 7 is significantly higher than the rate of Control Treatment 2. While for the second three treatment days with nitric acid, the leaching rate of Chemical Treatment 7 is lower than the Control Treatment 2. Such results show that the sodium hydroxide solution is more effective in leaching of fluoride impurities as compared with ultrapure water and nitric acid.

As for the organic impurities, the results shown in FIG. 5C indicate that the leaching rate of Chemical Treatment 7 is higher as compared with the leaching rate of control treatment. It indicates that both sodium hydroxide and nitric acid solution are effective in leaching of organic impurities from PVDF piping materials.

To further confirm the cleaning effect of Chemical Treatment 7, the PVDF test spools treated with Control Treatment 2 and Chemical Treatment 7 are soaked in ultrapure water, respectively. The average leaching amounts of impurities from the piping materials into the ultrapure water with the span of one week are analyzed accordingly. The results are shown in Table 2.

TABLE 2

| | | | Chemical |
|---|---|---|---|
| | | Control Treatment 2 | Treatment 7 |
| Average leaching | Metal ions | 2.15 | 0.30 |
| amount of | Fluoride ions | 7.40 | 1.65 |
| impurities | Organic | 29.10 | 9.55 |
| (μg/m² · day) | compounds | | |

The results in Table 2 show that after the cleaning process using ultrapure water (Control Treatment 2), the amounts of the leachates from the piping materials detected in the water sample are still high. While the leachates from the piping materials treated with Chemical Treatment 7 are much less as compared with control treatment, it indicates that Chemical Treatment 7 is an effective process to clean the piping materials.

Besides the chemical treatment steps (cleaning steps), the rinsing steps between alkaline treatment and acid treatment step and after acid treatment steps should also be mentioned. The chemicals and impurities can be possibly carried over to following steps and may influence the final cleaning effect due to insufficient rinsing. To evaluate the influence of the rate of rinsing on the effectiveness of Chemical Treatment 7, a test named Chemical Treatment 8 has been prepared. The chemical treatment steps of Chemical Treatment 8 are performed under the same conditions as Chemical Treatment 7, except that the flow rate of the rinsing steps with ultrapure water after chemical treatment is increased to around 0.2 m/s. After the cleaning process has been completed, the PVDF test spools treated with Chemical Treatment 7 and Chemical Treatment 8 are soaked in ultrapure water, respectively. Table 3 shows the average leaching amounts of the impurities from the piping materials into the ultrapure water with the span of one week after the cleaning treatments.

TABLE 3

| | | | Chemical |
|---|---|---|---|
| | | Chemical Treatment 7 | Treatment 8 |
| Average leaching | Metal ions | 0.30 | 0.15 |
| amount of | Fluoride ions | 1.65 | 0.25 |
| impurities | Organic | 9.55 | 5.10 |
| (μg/m² · day) | compounds | | |

The results in Table 3 show that the amount of the leachates from PVDF piping materials is further decreased by using the cleaning process of Chemical Treatment 8 as compared with Chemical Treatment 7. Such results indicate that a dynamic rinsing step between chemical treatment steps may be beneficial to remove the impurities sufficiently.

In the above chemical treatment tests, the sodium hydroxide and nitric acid cleaning steps are completed in static state. To evaluate the effect of flow rate on the chemical treatment steps, two chemical treatment tests (as below) parallel with Chemical Treatment 8 have been performed.

Chemical Treatment 9: treated with sodium hydroxide solution (10 ppm) with flow rate of 0.2 m/s for three days, first rinsing, following by nitric acid solution (10 ppm) with flow rate of 0.2 m/s for three days, second rinsing.

Chemical Treatment 10: treated with sodium hydroxide solution (10 ppm) with flow rate of 0.6 m/s for three days, first rinsing, following by nitric acid solution (10 ppm) with flow rate 0.6 m/s for three days, second rinsing.

The rinsing steps of these chemical treatments are performed under same conditions, i.e., rinsing the piping materials by ultrapure water with a flow rate around 0.2 m/s for several minutes. The completion of the rinsing step can be determined by the pH of the rinsing water, which reaches a predetermined pH level of 7.0 to 7.5.

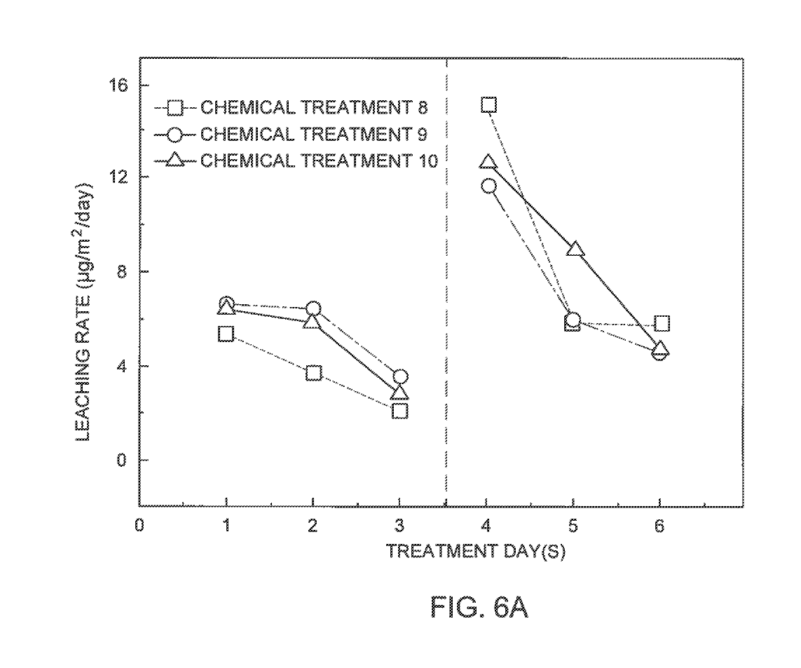

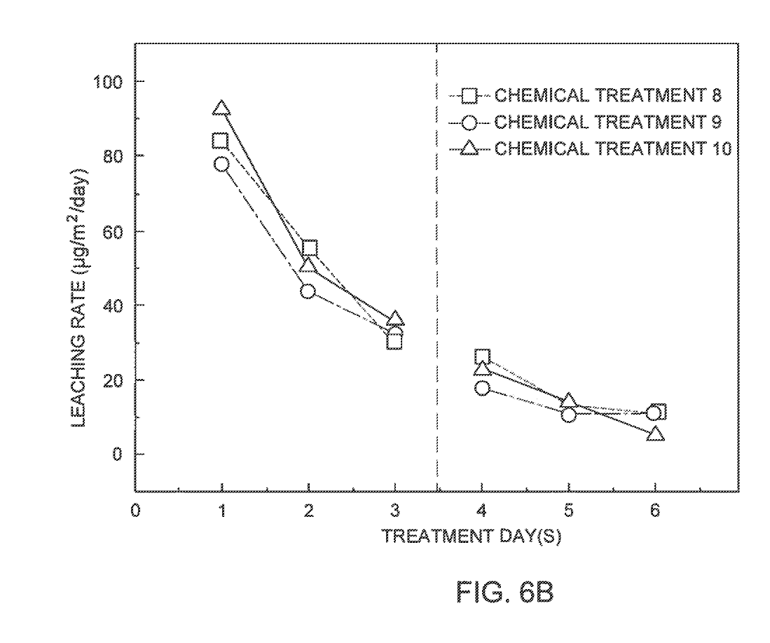

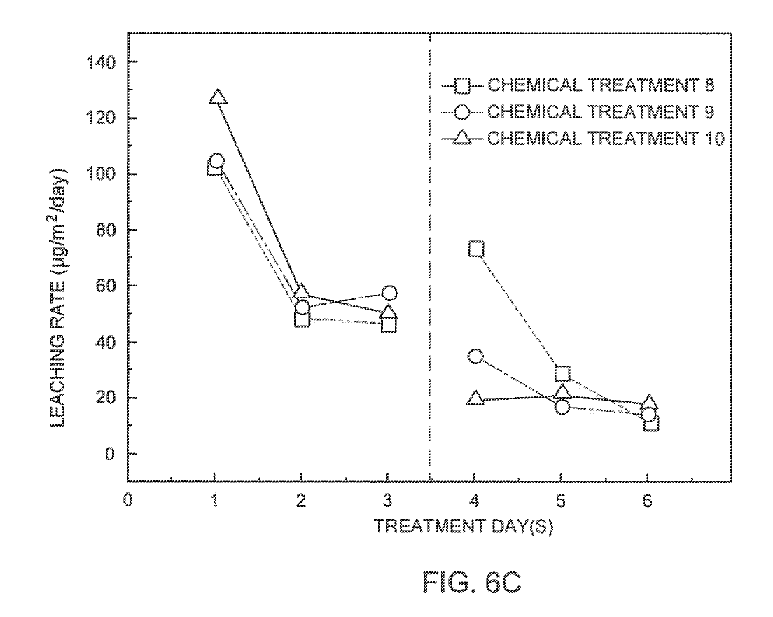

The comparison of the leaching rate of inorganic impurities, i.e., metal ions and fluoride, and organic impurities, from piping materials by using Chemical Treatment 8, Chemical Treatment 9, and Chemical Treatment 10, are shown in FIG. 6A to FIG. 6C, respectively.

The results in FIG. 6A show that the leaching rates of the metal ions impurities from the piping materials have no significant changes as the flow rate of the chemical treatment increased, which indicate that the flow rate is not the necessary condition for effective and efficient leaching of metal ions impurities from the piping materials.

As for the fluoride impurities, the results in FIG. 6B show that there are no significant differences in the leaching rate for these chemical treatment processes. It indicates that the flow rate is not the necessary condition for effective and efficient leaching of fluoride ions impurities from the piping materials.

Similarly, for organic impurities, there are no significant differences in the leaching rates for these chemical treatment processes as the results shown in FIG. 6C. It indicates that the flow rate is not the necessary condition for effective and efficient leaching of organic impurities from the piping materials.

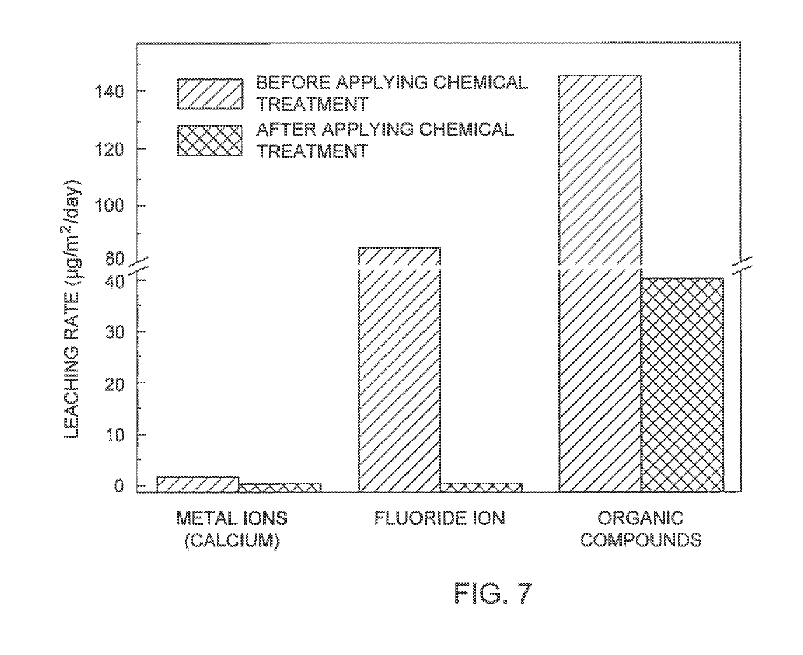

The bar chart listed in FIG. 7 shows the impurities amount of metal ion (calcium), fluoride ion, and organic compounds leach out from the piping materials with and without applying chemical treatment after seven days. It is obvious that by applying chemical treatment, the impurities amount detected is significant decreased, which indicates that the piping materials have been effectively cleaned by the chemical cleaning method proposed herein.

It is thus apparent that in one aspect of the invention, a method is provided for cleaning the entirety or portions of an ultrapure water supply system. Typically, such systems are connected to a process point of use such as in a semiconductor manufacturing process wherein the ultrapure water may be used to wash semiconductor wafers. These ultrapure water supply systems may comprise pipes, tanks, pumps, joints, filters, and other devices adapted to convey ultrapure water to the process usage location. Many of such ultrapure water supply systems include piping and other components composed of PVDF (polyvinylidene difluoride).

As per the above, it is not essential that the entire ultrapure water supply system be treated. In certain embodiments, only a portion or portions of such system are treated. In such cases, the component or components of the system, such as pipes, joints, filters, membrane filters, etc., may be individually cleaned or cleaned as a part of a sub-combination of the system. For example, the cleaning treatments such as alkaline treatment, rinsing, and acidic solutions, may be introduced into a to-be-cleaned part or sub-combination of components of the system from a location immediately upstream of the to-be-cleaned part and they may be discharged from a location immediately downstream of the to-be-cleaned part, thereby letting the cleaning liquid flow through the to-be-cleaned part or combination of parts. Instead of causing the cleaning liquid to flow through the to-be-cleaned part, the to-be-cleaned part may be simply filled with the cleaning liquid, and after a lapse of a predetermined time, the cleaning liquid(s) and rinsing solution may be discharged from the to-be-cleaned part.

In one aspect of the invention, the method is employed to clean newly constructed or newly installed water supply systems before same are put into actual usage. Conversely, the methods can also be applied to ultra pure water supply systems after same have been put into usage by disconnection of the system or components thereof from the process point of use followed by employment of the cleaning methods to the system or component parts thereof.

In view of the above detailed description, it is obvious to those skilled in the art that various modifications are possible without departing from the spirit and the scope of the present disclosure.

It is to be understood that even though numerous characteristics and advantages of various embodiments have been set forth in the foregoing description, together with details of the structure and functions of various embodiments, this disclosure is illustrative only, and changes may be made in detail, especially in matters of structure and arrangement of parts within the principles of the embodiments to the full extent indicated by the broad general meaning of the terms in which the appended claims are expressed. It will be appreciated by those skilled in the art that the teachings disclosed herein can be applied to other systems without departing from the scope and spirit of the application.

What is claimed is:

1. A method for cleaning an ultrapure water supply system or component part thereof comprising the steps of:
contacting said system or component part with an alkaline cleaning solution;
rinsing said system or component part for a first time;
contacting said system or component part with an acidic solution; and
rinsing said system or component part for a second time after contacting said system or component part with an acidic solution.

2. The method as recited in claim 1, wherein said ultrapure water system comprises component parts composed of polyvinylidene fluoride (PDVF).

3. The method as recited in claim 2, wherein said alkaline cleaning solution comprises NH₄OH or alkali metal hydroxide.

4. The method as recited in claim 3, wherein said alkaline cleaning solution comprises NH₄OH.

5. The method as recited in claim 3, wherein said alkaline cleaning solution comprises alkali metal hydroxide, said alkali metal hydroxide comprising a member selected from the group consisting of NaOH and KOH.

6. The method as recited in claim 5, wherein said alkali metal hydroxide comprises NaOH.

7. The method as recited in claim 2, wherein said acidic solution comprises a mineral acid.

8. The method as recited in claim 7, wherein said mineral acid is a member selected from the group consisting of nitric acid, sulphuric acid, and hydrochloric acid.

9. The method as recited in claim 8, wherein said mineral acid comprises nitric acid.

10. The method as recited in claim 2, wherein said method steps are conducted at ambient temperature.

11. The method as recited in claim 3, wherein said NH₄OH or alkali metal hydroxide is present in said alkaline solution in a concentration of about 0.5-200 ppm.

12. The method as recited in claim 11, wherein said NH₄OH or alkali metal hydroxide is present in said alkaline solution in a concentration of about 2 to about 10 ppm.

13. The method as recited in claim 7, wherein said mineral acid is present in said acidic solution in an amount of about 0.5 ppm to 200 ppm.

14. The method as recited in claim 13, wherein said mineral acid is present in said acidic solution in an amount of about 2 to about 10 ppm.

15. The method as recited in claim 4 wherein the first rinsing step is performed for a period of about 12 hours to about 15 days.

16. The method as recited in claim 15 wherein the first rinsing step is performed for a period of about two to about five days.

17. The method as recited in claim 1 wherein said step of contacting said system or component part with an acidic solution is performed for a period of 12 hours to about 15 days.

18. The method as recited in claim 17 wherein said step of contacting said system or component part with an acidic solution is performed for a period of about two to about five days.

19. The method as recited in claim 1 wherein said first and second rinsing steps comprise dynamic rinsing steps wherein a rinsing solution is flowed through said ultrapure water supply system or component part at a flow rate of 0.2 m/s or greater.

20. The method as recited in claim 1, wherein all of the steps are conducted at temperatures of about 10-40° C.

21. (canceled)

22. (canceled)
